(19) United States
(12) Patent Application Publication
(10) Pub. No.: US 2004/0225976 A1
(43) Pub. Date: Nov. 11, 2004

(54) Glitch free programmable delay line for edge sensitive design

(76) Inventors: Daniel Y. Cheung, Cupertino, CA (US); Fabrizio Romano, Santa Clara, CA (US); Ivana Cappellano, Palermo (IT)

Correspondence Address: ZAGORIN O'BRIEN & GRAHAM, L.L.P., 7600B N. CAPITAL OF TEXAS HWY., SUITE 350, AUSTIN, TX, 78731, US

(21) Appl. No.: 10/158,817

(22) Filed: May 30, 2002

(51) Int. Cl. G06F 17/50

(52) U.S. Cl. 716/6

(57) ABSTRACT

A programmable delay line is introduced that produces a delayed signal that is glitch free and without metastability conditions. The programmable delay line includes a synchronizer circuit and a programmable delay circuit. The synchronizer circuit is configured to receive an input signal and one or more control signals. The synchronizer circuit synchronizes the one or more control signals to the input signal, producing one or more synchronized control signals. The programmable delay circuit is configured to utilizing the synchronized control signals to add an amount of delay to the input signal, producing a delayed version of the input signal that is glitch free and without metastability conditions. The control signals control the amount of delay added to the input signal based on, for example, process, voltage and temperature (PVT) variations.

### BACKGROUND OF THE INVENTION

1. Field of the Invention

The present invention relates to the field of electronic circuits and more particularly to programmable delay lines.

2. Description of the Related Art

In computer and information processing systems, various integrated circuit chips communicate digitally with each other over common buses. The rate at signals are transmitted over the common buses define the speed at which the integrated circuit chips communicate with each other. The maximum transmission rate depends on the time that it takes for the electromagnetic wavefronts (i.e., signals) to propagate the bus from one chip to another and the settling time or the time required for the signals to settle to levels that can be reliably recognized by the receiving chip as being HIGH (i.e., a digital one) or LOW (i.e., a digital zero).

Integrated circuit chips contain drivers which drive conductive lines in accordance with signals received by the drivers. The operating characteristics of transistors such as CMOS transistors, from which drivers of integrated circuit chips are typically constructed, vary with process, voltage, temperature (PVT) variations. For example, the drive strength of chip drivers vary with PVT variations. Drivers are stronger if the operating temperature of their transistors is lower or the supply voltage provided thereto is higher. Drivers are weaker if their operating temperature is higher or the supply voltage provided thereto is lower. The actual strength of drivers may not match the expected strength due to unexpected and permanent variations in the physical structure of the transistors that form the drivers. Chips including their drivers are manufactured on silicon wafers using complex equipment and processes. Once completed, the integrated circuit chips are severed from the silicon wafer and individually packaged for subsequent use. A single wafer, depending on its size, is capable of producing several integrated circuit chips. In theory, each of these chips should be identical to each other in physical structure. In practice, slight physical variations exist between these chips. For example, due to variations in the fabrication process, the doping density in the source or drain regions of certain transistors, or the length or width of gates of certain transistors of drivers, may unexpectedly vary from chip to chip. These physical variations in the FETs are static in nature and may unexpectedly increase or decrease the drive strength of the chip's drivers.

If inadequate compensation is made for PVT variations in the drivers of integrated circuit chips, the drive strength of the drivers will vary. A variation in the driver drive strength will affect the time it takes for signals generated by the drivers to propagate the bus from one chip to another and/or the time required for the signals generated by the drivers to settle to levels that can be reliably recognized by the receiving chip. As such the variations in PVT will affect the rate at which signals are actually transmitted over the bus coupling integrated circuit chips.

One solution to compensating for the effects of changes in PVT is to use a programmable delay line that varies with PVT variations. Although programmable delay lines are used in a variety of circuits, they are particularly useful to compensate for PVT variations in high speed circuits, for example, double data rate (DDR) memory and stub-series-terminated logic (SSTL) environments. The delay is programmed as the environment changes (for example, voltage and temperature) to fulfill tight timing requirements for signals transmitted over the bus.

The use of programmable delays can be problematic for certain edge sensitive signals, such as a DQS strobe of DDR memory or other clocking or strobe signals. These signals are sensitive to glitches and metastability often caused by programmable delays. Glitches or metastability can cause a malfunction of the design. A malfunctioning edge-sensitive signal can cause a system to fail to access the correct data and other related errors.

FIG. 1A, labeled prior art, illustrates an exemplary delay line circuit 100. Both signals A and B are fed into a multiplexer 110. Signal B is a delayed version of signal A, produced by delay 115. Control signal C is the select line for multiplexer 110, selecting between signal A and B to produce a signal D.

FIG. 1B, labeled prior art, illustrates a timing diagram of the operation of circuit 100 of FIG. 1A. As shown, signal B is a delayed version of signal A. A switch window 120 illustrates a period of time in which signal A and signal B have different values (such as after the transition of signal A but before the transition of signal B). If signal C, the select line for multiplexer 110, switches during switch window 120 (or another switch window), an unwanted glitch or metastability can occur. The unwanted glitch or metastability condition can cause a malfunction in the circuit, especially if signal D is an edge sensitive signal such as a strobe or clocking signal.

### SUMMARY OF THE INVENTION

In accordance with the present invention, a programmable delay line is introduced that produces a delayed signal that is glitch free and without metastability conditions. The programmable delay line includes a synchronizer circuit and a programmable delay circuit. The synchronizer circuit is configured to receive an input signal and one or more control signals. The synchronizer circuit synchronizes the one or more control signals to the input signal, producing one or more synchronized control signals. The programmable delay circuit is configured to utilizing the synchronized control signals to add an amount of delay to the input signal, producing a delayed version of the input signal that is glitch free and without metastability conditions. The control signals control the amount of delay added to the input signal based on, for example, process, voltage and temperature (PVT) variations.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1A, labeled prior art, illustrates an exemplary delay line circuit.

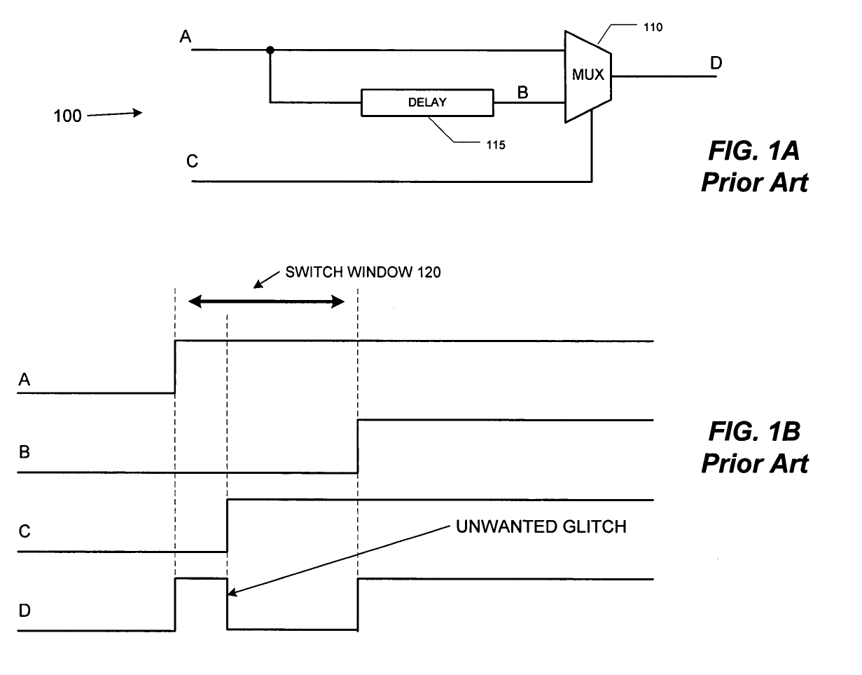

FIG. 1B, labeled prior art, illustrates a timing diagram of the operation of the circuit of FIG. 1A.

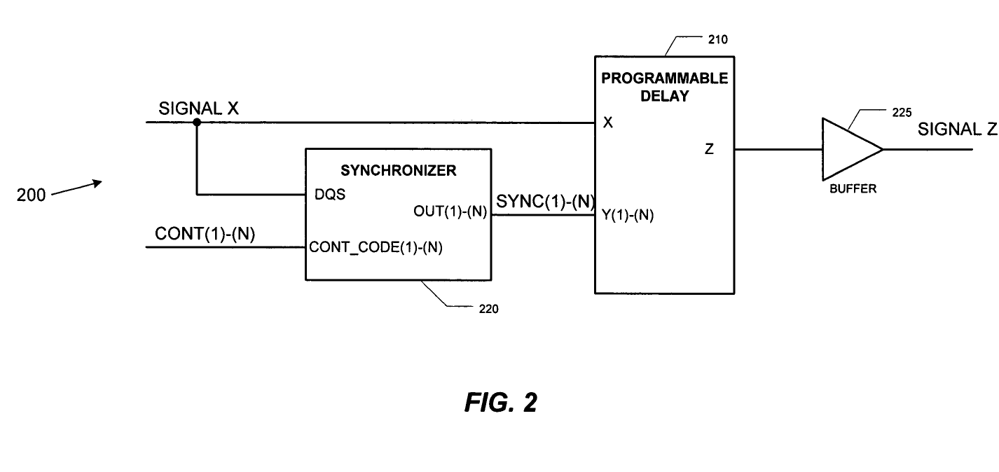

FIG. 2 illustrates a top level diagram of an electronic circuit according to an embodiment of the present invention.

FIG. 3 illustrates a circuit diagram of synchronizer block 220 of FIG. 2.

FIG. 4 illustrates a timing diagram of the operation of portions of synchronizer 220 of FIG. 3.

FIG. 5 illustrates a circuit diagram of programmable delay block 210 of FIG. 2.

FIG. 6 illustrates an exemplary circuit of a multiplexer such as multiplexer 510 of FIG. 5.

FIGS. 7A-7B illustrate timing diagrams of the operation of circuit 200 operation.

The use of the same reference symbols in different drawings indicates similar or identical items.

### DETAILED DESCRIPTION

The following is intended to provide a detailed description of an example of the invention and should not be taken to be limiting of the invention itself. Rather, any number of variations may fall within the scope of the invention that is defined in the claims following the description.

### Introduction

According to embodiments of the present invention, an n-bit control signal controls the amount of programmable delay added to a signal. The n-bit control signal is first synchronized to the signal to avoid glitches and metastability conditions on the signal.

A programmable delay circuit provides the necessary programmable delay, while a synchronizer circuit synchronizes the n-bit control signal to the signal to prevent glitches and metastability of the delayed signal. Prevention of glitches and metastability conditions on the delayed signal is critical for proper circuit operation, particularly when adding a programmable delay to an edge sensitive signal such as a DQS strobe signal of Double Data Rate (DDR) memory.

### Example Circuitry

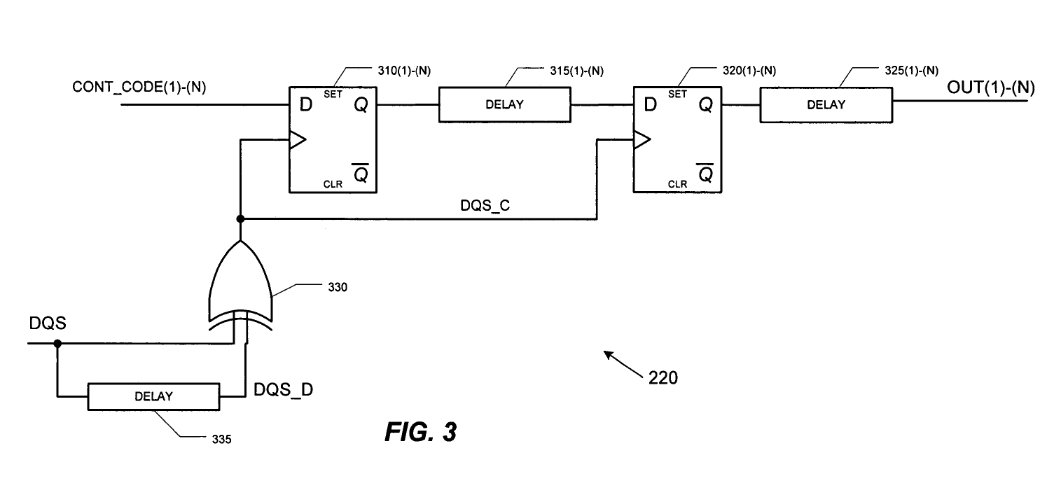

FIG. 2 illustrates a top level diagram of an electronic circuit 200 according to an embodiment of the present invention. Signal X, the signal to be delayed, is received by a programmable delay circuit 210 and a synchronizer 220. Synchronizer 220 also receives CONT(1)-(N), an n-bit control signal that is used to control the amount of delay added to signal X. N can be any integer, one or greater. Synchronizer block 220 synchronizes CONT(1)-(N) to signal X generating SYNC(1)-(N), an n-bit synchronized control signal.

To increase the speed of an interface, a programmable delay is typically added to a signal such as signal X. The programmable delay varies, for example, with PVT variations. The n-bit control signal CONT(1)-(N) is used to vary the amount of delay added to signal X. CONT(1)-(N), can be, for example, an “impedance-control code” received by the circuit from outside circuitry, such as that described in U.S. Pat. No. 6,085,033, hereby incorporated by reference and used to control the impedance of a driver across PVT variations. It is understood, however, that the n-bit control signal can alternatively come from other sources.

SYNC(1)-(N) is received by programmable delay 210. Programmable delay block 210 provides various delay options which are selected by SYNC(1)-(N) and produces signal Z, a delayed version of signal X. A buffer 225 is optionally used to increase the drive strength of signal Z. Because SYNC(1)-(N) is synchronized to signal X, glitches and metastability issues on signal Z are avoided.

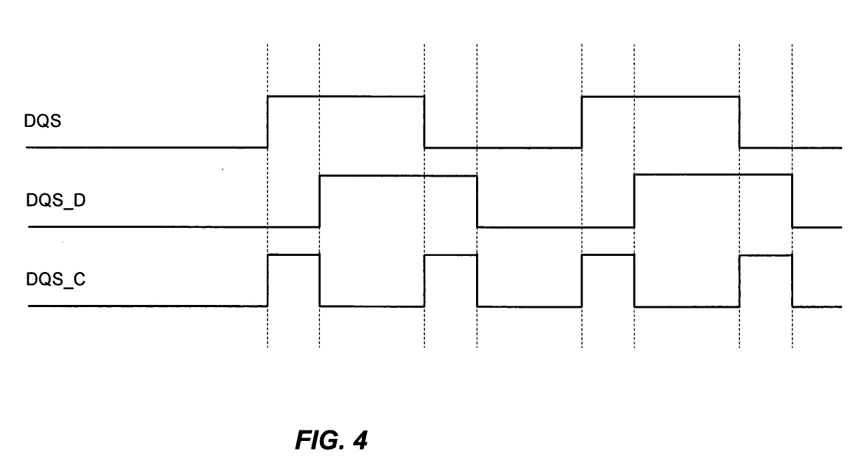

FIG. 3 illustrates a circuit diagram of synchronizer block 220 of FIG. 2. CONT_CODE(1)-(N) are received by flip flops 310(1)-(N), respectively. For purposes of illustration, only one of the flip flops 310(1)-(N) is shown. The outputs of flip flops 310(1)-(N) are coupled to delays 315(1)-(N), respectively. For purposes of illustration, only one of the delays 315(1)-(N) is shown. The outputs of delays 315(1)-(N) are coupled to flip flops 320(1)-(N), respectively. For purposes of illustration, only one of the flip flops 320(1)-(N) is shown. The outputs of flip flops 320(1)-(N) are coupled to delays 325(1)-(N), respectively. For purposes of illustration, only one of the delays 325(1)-(N) is shown. Delays 325(1)-(N) produce OUT(1)-(N), respectively, in response to flip flops 310(1)-(N) receiving CONT_CODE(1)-(N). OUT(1)-(N) is a synchronized version of CONT-CODE(1)-(N).

Delays 315(1)-(N) are as small as possible, but large enough to meet hold time requirement of flip flops 320(1)-(N). Delays 325(1)-(N) are large enough to avoid the switch window (in which signal X and the delayed versions of signal X do not have the same value or signal level) of a multiplexer in programmable delay block 210. Delays 325(1)-(N) may be equal to each other. Alternatively, delays 325(1)-(N) may have values which are different from each other. Flip flops 310(1)-(N) and flip flops 320(1)-(N) are clocked by a DQSC signal produced by a two input XOR gate 330. A DQS signal is received by XOR gate 330. In addition, a delayed version of DQS signal, produced by delay 335 is received by XOR gate 330. Delay 335 controls the pulse width for XOR gate 330.

In an alternate embodiment of circuit 220, XOR gate 330 can be eliminated and the DQS signal routed to directly clock flip flops 310(1)-(N) and flip flops 320(1)-(N). However, the response time of the electronic circuit 200 to a change in CONT(1)-(N) is two Signal X cycles longer.

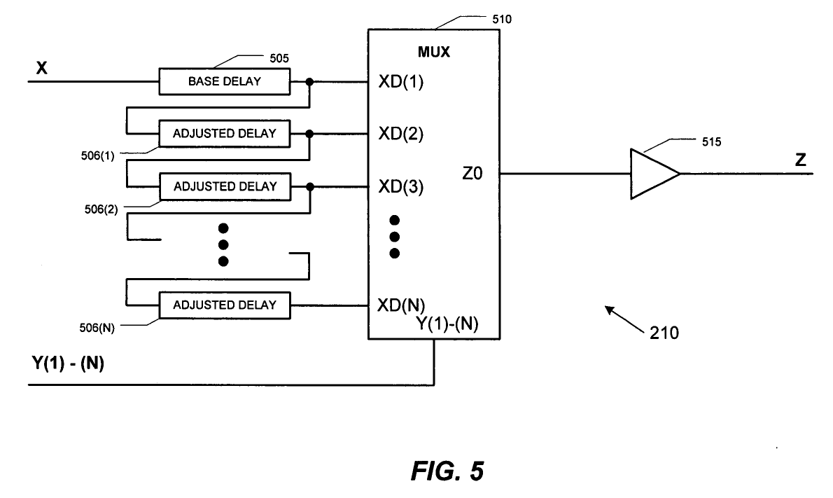

FIG. 4 illustrates a timing diagram of the operation of portions of synchronizer 220 of FIG. 3. As shown, DQS is a periodically toggling signal, such as a strobe or a clocking signal. DQS_D is a delayed version of DQS, delayed by delay 335. Both DQS and DQS_D are fed into XOR gate 330, producing signal DQS_C. DQS_C is a signal that toggles for each rising and falling edge of signals DQS and DQS_D.

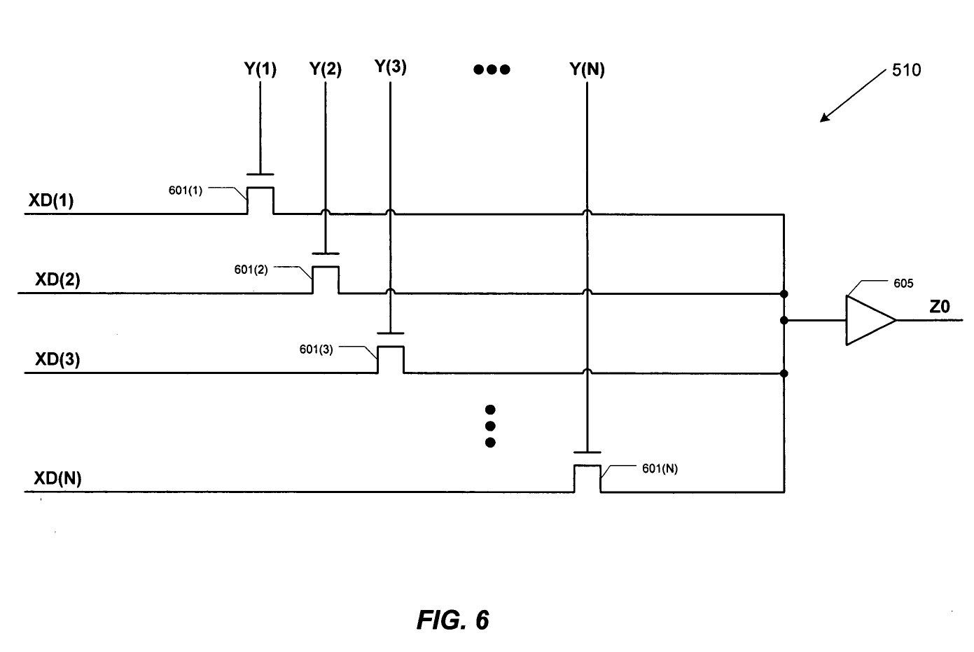

FIG. 5 illustrates a circuit diagram of programmable delay block 210 of FIG. 2. An input signal X is received by a base delay block 505 and a series of one or more adjusted delay blocks 506(1)-(N) connected in series. Outputs of base delay block and each of the one or more adjusted delay blocks 506(1)-(N) are received by a multiplexer 510. Control signal Y(1)-(N) is input to multiplexer 510 and controls the selection of the outputs of the one or more delay blocks 505(1)-(N) producing signal Z.

The base delay and the adjusted delays can be tuned as needed, for example, tuned for process, voltage, and temperature. The amount of delay added to input signal X from each of adjusted delays 506(1)-(N) can be the same or a function of the previous delay. For example, if N=8, each of adjusted delays 506(1)-(N) can add 7% of the accumulated delay. For example, if base delay 505 adds M delay to input signal X, adjusted delay 506(1) adds (0.07)*(M), adjusted delay 506(1) adds (0.07)*(M+(0.07)*(M)), and so on. The 7% scheme provides a range of delayed signals that are useful for PVT adjustments.

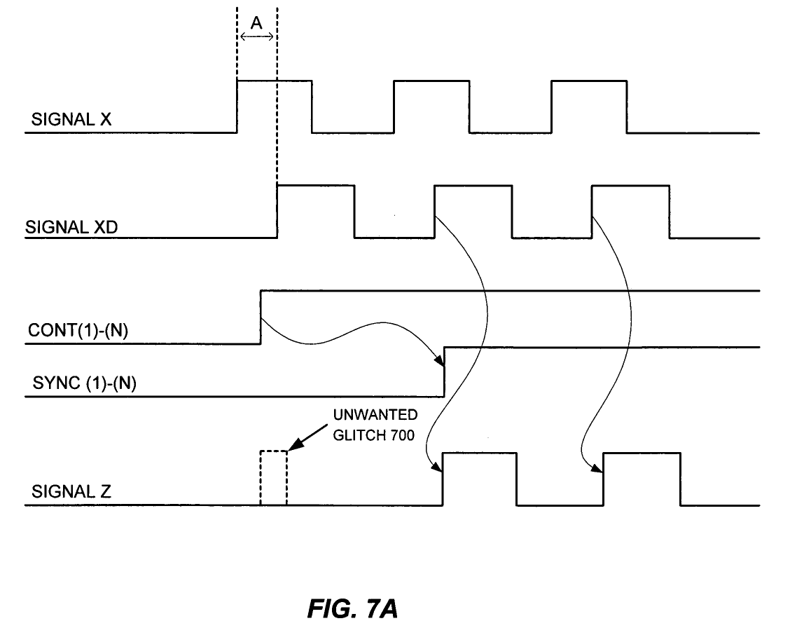

FIG. 6 illustrates a circuit of a multiplexer such as multiplexer 510 of FIG. 5. Input signals XD(1)-(N) are selected by control signals Y(1)-(N) through transistors 601(1)-(N) and output as signal Z0. Typically only one of control signals Y(1)-(N) are active at a given time. Optionally, a buffer 605 can be used to increase the drive strength of signal Z0.

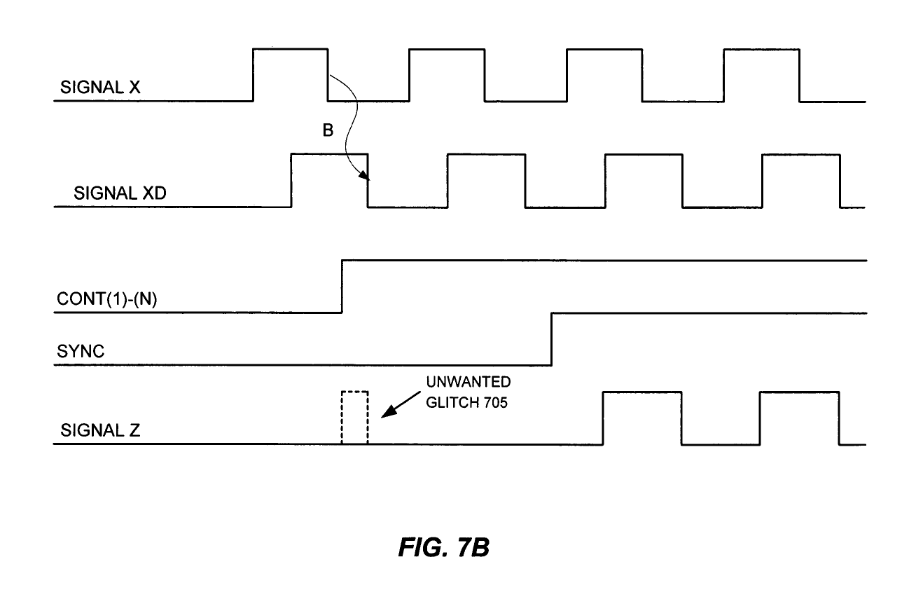

FIG. 7A illustrates a timing diagram of circuit 200 operation. As shown, signal X is a periodically toggling signal. Signal XD is a delayed version of signal X. Signal XD is, for example, one of the delayed signals produced by base delay block 505 or adjusted delay blocks 506(1)-(N). The amount of delay added to signal X to produce signal XD is selected by Y(1)-(N). Y(1)-(N), can be for example, OUT(1)-(N) of FIG. 3.

A switch window A occurs when signal X has transitioned to a high level, but signal XD has not yet transitioned. As shown, CONT(1)-(N) transitions during switch window A. According to the present invention, CONT(1)-(N) is first synchronized to signal X, producing SYNC(1)-(N), prior to changing the amount of delay added to signal X. As shown in outline, unwanted glitch 700 is prevented by circuit 200.

FIG. 7B illustrates another timing diagram of the operation of circuit 200 operation. As shown, signal X is a periodically toggling signal. Signal XD is a delayed version of signal X. The amount of delay added to signal X to produce signal XD is selected by CONT(1)-(N).

A switch window B occurs when signal X has transitioned to a low level, but signal XD has not yet transitioned. As shown, CONT(1)-(N) transitions during switch window B. According to the present invention, CONT(1)-(N) is first synchronized to signal X, producing SYNC(1)-(N), prior to changing the amount of delay added to signal X. As shown in outline, unwanted glitch 705 is prevented by circuit 200.

The present invention utilizes a synchronized n-bit control signal to control the amount of programmable delay added to a signal. By first synchronizing the n-bit control signal to the signal, glitches and metastability conditions on the delayed signal are avoided.

A programmable delay circuit provides the necessary programmable delay, while a synchronizer circuit synchronizes the n-bit control signal to the signal to prevent glitches and metastability of the delayed signal. Prevention of glitches and metastability conditions on the delayed signal is critical for proper circuit operation, particularly when adding a programmable delay to an edge sensitive signal, for example, an edge sensitive signal such as a DQS strobe signal of Double Data Rate (DDR) memory.

Other embodiments are within the following claims. Also, while particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

1. A programmable delay line comprising:
a synchronizer circuit; and
a programmable delay circuit coupled to the synchronized circuit;
wherein the synchronizer circuit is configured to receive an input signal and one or more control signals and to produce one or more synchronized versions of the one or more control signals, and
wherein the programmable delay circuit is configured to receive the input signal and the one or more synchronized versions of the one or more control signals and produce a delayed version of the input signal.

2. The programmable delay line as recited in claim 1, wherein the delayed version of the input signal is glitch-free.

3. The programmable delay line as recited in claim 1, wherein the programmable delay circuit produces the delayed version of the input signal by using the one or more synchronized versions of the one or more control signals to select an amount of delay to add to the input signal.

4. The programmable delay line as recited in claim 1, wherein the one or more synchronized control signals is synchronized to the input signal.

5. The programmable delay line as recited in claim 1, wherein the delayed version of the input signal is a frequently toggling signal and is edge sensitive.

6. The programmable delay line as recited in claim 1, wherein the delayed version of the input signal is a double data rate (DDR) memory DQS strobe signal.

7. The programmable delay line as recited in claim 1, wherein the one or more synchronized control signals vary an amount of delay added to the input signal based on process, voltage and temperature (PVT) variations.

8. A method of providing a programmable delay line comprising:
synchronizing one or more control signals to an input signal;
utilizing the one or more control signals to select an amount of delay to add to the input signal to produce a delayed version of the input signal.

9. The method as recited in claim 8, wherein the delayed version of the input signal is glitch-free.

10. The method as recited in claim 8, wherein the delayed version of the input signal is a frequently toggling signal and is edge sensitive.

11. The method as recited in claim 8, wherein the delayed version of the input signal is a double data rate (DDR) memory DQS strobe signal.

12. The method as recited in claim 8, wherein one or more control signals vary an amount of delay added to the input signal based on process, voltage and temperature (PVT) variations.

13. A programmable delay line comprising:
means for synchronizing one or more control signals to an input signal;
means for utilizing the one or more control signals to select an amount of delay to add to the input signal to produce a delayed version of the input signal.

14. The programmable delay line as recited in claim 13, wherein the delayed version of the input signal is glitch-free.

15. The programmable delay line as recited in claim 13, wherein the delayed version of the input signal is a frequently toggling signal and edge sensitive.

16. The programmable delay line as recited in claim 13, wherein the delayed version of the input signal is a double data rate (DDR) memory DQS strobe signal.

17. The programmable delay line as recited in claim 13, wherein one or more control signals vary an amount of delay added to the input signal based on process, voltage and temperature (PVT) variations.

18. A method comprising:
synchronizing one or more control signals to an input signal to produce one or more synchronized control signals; and
controlling a programmable delay to produce a programmably delayed input signal using the one or more synchronized control signals.

19. The method as recited in claim 18, wherein synchronizing comprises:
clocking the control signal through a plurality of flip-flops using the input signal.

20. The method as recited in claim 19, wherein clocking the control signal includes providing either an intermediate delayed version of the input signal or an undelayed version of the input signal to clock inputs of each of the plurality of flip-flops.

21. The method as recited in claim 20, wherein providing includes selecting either the intermediate delayed version or the undelayed version.

22. The method as recited in claim 18, wherein the programmably delayed version of the input signal is glitch-free.

23. The method as recited in claim 18, wherein controlling the programmable delay includes using the one or more synchronized control signals to select an amount of delay to add to the input signal.

24. The method as recited in claim 18, wherein the programmably delayed version of the input signal is a double data rate (DDR) memory DQS strobe signal.

25. The method recited in claim 18, wherein the one or more synchronized control signals vary an amount of delay added to the input signal based on process, voltage and temperature (PVT) variations.

26. An apparatus comprising:
a synchronizer to synchronize one or more control signals to an input signal and to produce one or more synchronized control signals; and
a programmable delay coupled to produce a programmably delayed input signal based on the one or more synchronized control signals.

27. The apparatus as recited in claim 26, wherein the synchronizer comprises:
a plurality of flip-flops coupled to clock the control signal in with the input signal.

28. The apparatus as recited in claim 27, wherein the synchronizer further includes clocking the control signal includes logic to selectively provide either an intermediate delayed version of the input signal or an undelayed version of the input signal to clock inputs of each of the plurality of flip-flops.

29. The apparatus as recited in claim 26, wherein the programmably delayed version of the input signal is glitch-free.

30. The apparatus as recited in claim 26, wherein the programmable delay selects an amount of delay to add to the input signal based on the one or more synchronized control signals.

31. The apparatus as recited in claim 26, wherein the programmably delayed version of the input signal is a double data rate (DDR) memory DQS strobe signal.

32. The apparatus recited in claim 26, wherein the one or more synchronized control signals vary an amount of delay added to the input signal based on process, voltage and temperature (PVT) variations.
